(19) United States
(12) Patent Application Publication
(10) Pub. No.: US 2004/0212681 A1
(43) Pub. Date: Oct. 28, 2004

(54) Intelligent broadcasting control system

(76) Inventor: Soon-Koo Cho, Seoul (KR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/485,813

(22) PCT Filed: Sep. 8, 2002
(86) PCT No.: PCT/KR02/01521

(30) Foreign Application Priority Data
Aug. 10, 2001 (KR) 2001/48153

(51) Int. Cl. H04N 7/173; H04N 17/00; H04N 7/16; H04N 17/02

(52) U.S. Cl. 348/192; 725/107; 725/115; 725/116; 725/146

(57) ABSTRACT

Disclosed is an intelligent broadcasting control system mounted with a number of sound devices, wherein the system includes: a main controller for checking the state of the system and controlling devices connected to the system; a digital audio processor controlled by the main controller for adjusting the level of a sound source inputted from external sound source devices to a designated output level and for outputting sounds; an amplifier fault detector for self-detecting any fault in an amplifier connected to the system and automatically switching a faulty amplifier to an auxiliary amplifier; a relay group disposed between the amplifier fault detector and a speaker for controlling the speaker to which osund signals ouputted from the digital audio processor are outputted; and a permanent digital recorder and player for recording a broadcasting program under the control of the main controller in case broadcasting itself becomes impossible and broadcasting inputis required from the outside, whereby a pre-recorded broadcasting program can be broadcasted when a broadcastable circumstance is presented at a later time.

### TECHNICAL FIELD

The present invention relates to a sound broadcasting control system, and more specifically to a mass-producible intelligent broadcasting control system.

### BACKGROUND ART

In general, an exclusive broadcasting system refers to a system that is specially designed for broadcasting in a single building, such as, office buildings or hotels, or broadcasting for a desired specific area, floors or districts from an adjacent building. Under the Fire Services Act, buildings which fall within certain parameters are absolutely required to have an exclusive broadcasting system.

Normally, the exclusive broadcasting system is operated inside a single building. Keeping abreast with technical development associated with network configuration and local area network (LAN), a high quality exclusive broadcasting system will soon be available at a low price.

The exclusive broadcasting system is largely divided into two types: manual and automatic. In case of a manual exclusive broadcasting system, although it can be mass produced, a fundamental problem still arises in connection with malfunction of a manual type element, the diode. Also, one of the main concerns of a conventional automatic exclusive broadcasting system is that mass production is not possible, because it is specially manufactured to be adaptive to a broadcasting system on demand. As a result, users often have a difficult time to operate this system. In addition, its high price is also an intervening factor for purchasing the system.

Recently, an exclusive broadcasting system controlled by a personal computer is most commonly used. This exclusive broadcasting system with an automatic (unattended) operation system usually requires a security system, such as a CCTV or infrared detector, and an integrated broadcasting network connected to a main office or branch offices.

### DISCLOSURE OF INVENTION

It is an object of the present invention to provide an intelligent broadcasting control system.

Another object of the present invention is to provide an intelligent broadcasting control system that is capable of changing programs as viewers' wish, with the special ability to broadcast and operate from a place with sound facilities.

Still another object of the present invention is to provide an intelligent broadcasting control system that is mass producible.

To achieve the above objects, an intelligent broadcasting control system is provided, which includes: a main controller for checking the state of the system and controlling devices connected to the system; a digital audio processor controlled by the main controller for adjusting the level of a sound source inputted from external sound source devices to a predetermined output level and outputting sounds; amplifier fault detector for self-detecting any faults in an amplifier connected to the system and automatically switching a faulty amplifier to an auxiliary amplifier; a relay group disposed between the amplifier fault detector and a speaker for controlling the speaker to which sound signals outputted from the digital audio processor are outputted; and a permanent digital recorder and player for recording a broadcasting program under the control of a main controller in the case where broadcasting itself becomes impossible and where broadcasting input is required from the outside, whereby a pre-recorded broadcasting program can be broadcasted when a broadcastable circumstance is presented at a later time.

Preferably, the intelligent broadcasting control system further includes a computer connected to the main controller for setting up or monitoring the main controller.

Also, the main controller controls sound devices connected thereto by using a stream coding method.

The intelligent broadcasting control system according to the present invention is mass producible and can be easily used.

### BRIEF DESCRIPTION OF DRAWINGS

The above objects, features and advantages of the present invention will become more apparent from the following detailed description when taken in conjunction with the accompanying drawings, in which:

FIG. 1 is a block diagram illustrating an intelligent broadcasting control system in accordance with the present invention;

FIG. 2 is a front view of the intelligent broadcasting control system of FIG. 1; and

FIGS. 3 through 11 are flow charts explaining the operations of a main controller mounted in the intelligent broadcasting control system in accordance with the present invention.

### BEST MODE FOR CARRYING OUT THE INVENTION

A preferred embodiment of the present invention will now be described with reference to the accompanying drawings.

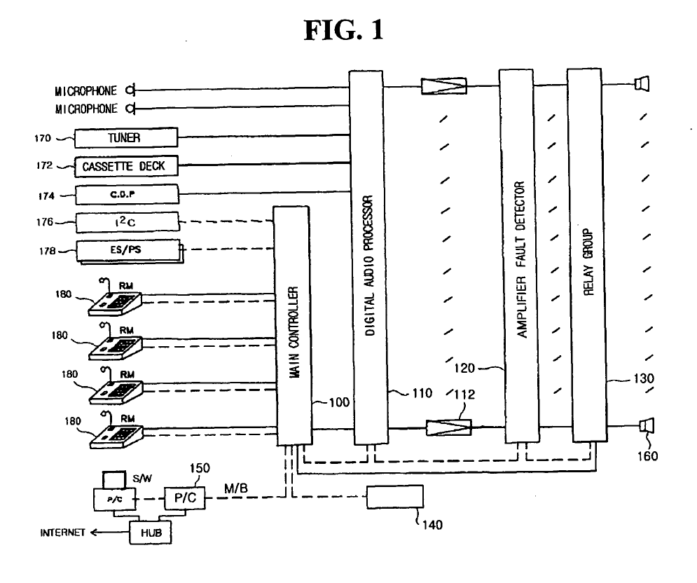

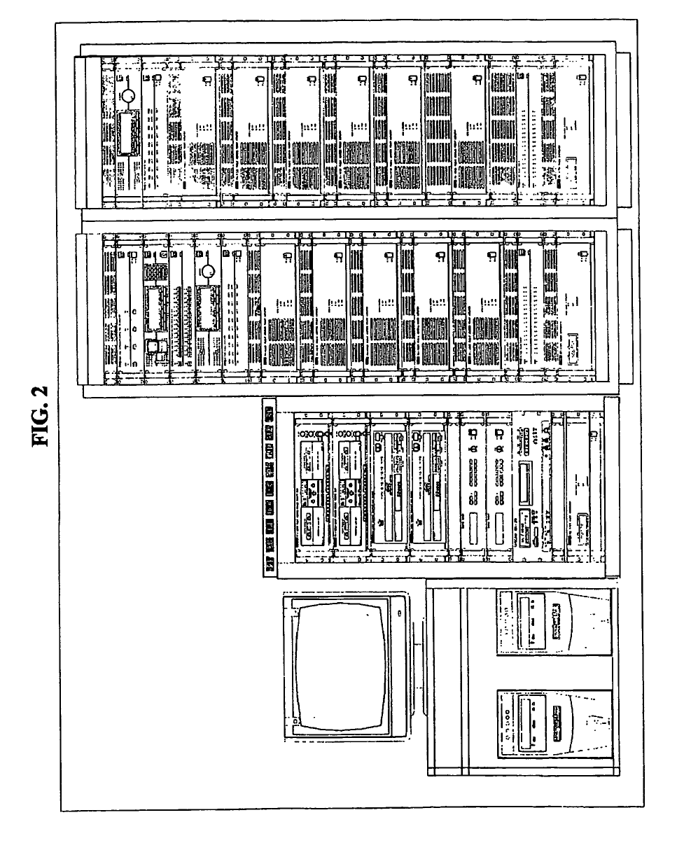

FIG. 1 is a block diagram illustrating an entire intelligent broadcasting control system in accordance with a preferred embodiment of the present invention.

Referring to FIG. 1, the intelligent broadcasting control system of the present invention consists of main controller 100 for checking and controlling audio devices connected to the system, digital audio processor 110, amplifier fault detector 120, permanent digital recorder and player 140, emergency switcher 178, speaker selector (PS) 180, and computer 150 connected to the main controller. Each element will be described in greater detail below.

Main controller 100 manages (or checks) the state of the system, controls devices connected to the system, and sets up the system and devices. Main controller 100 can be set up by the computer, and monitored through the monitor on the computer. Since information on broadcasting service areas of the system is set up on the computer connected to main controller 100, operation of the main controller can be adapted and varied according to different situations in the field; and each operation thereof can be monitored at a single glance.

Main controller 100 is mounted with a liquid crystal display (LCD) and a plurality of serial ports. It controls and checks the state of devices based on a stream coding method. The stream coding system will now be explained with reference to Table 1 below:

TABLE 1

| | | | |
|---|---|---|---|
| Header | ID Information of | Commands | Broadcasting |
| | Clients | | Information |

As shown in Table 1, a streaming format consists of a header, ID (identification) information of clients, commands, and broadcasting information. Hence, there is no limit to the number of devices sets connected to main controller 100; and the number of sets is only limited by the individual unit address setup.

On the other hand, main controller 100 uses RS232 or RS422 data communication systems, so its work efficiency is much better than when it is controlled by solid lines. As such, expenses for circuitry can be greatly reduced.

In addition, since main controller 100 has a built-in digilink port in a digilink format, it is able to control advance-broadcasting programs of sound sources, e.g. CD players (hereinafter referred to as “CDP”), cassette tape players (hereinafter referred to as “DECK”), or tuners.

Further, main controller 100 operates together with a relay group for monitoring outputs of speakers that are connected to the relay group.

Digital audio processor 110 receives sound signals from a number of sound sources, and outputs them to an amplifier. Generally used sound sources are remote amplifiers, microphones, CDP, DECK, or tuners. Particularly, the sound source relevant to emergency broadcasting or the sound source of remote amplifiers is provided by main controller 100. Meanwhile, the other sound sources, namely microphones, CDP, DECK, or tuners are used by directly connecting them to the system or via other devices like a mixer.

If amplifier fault detector 120 is employed, sound signals outputted from digital audio processor 110 are outputted to an amplifier via a fault detector.

Digital audio processor 110 is equipped with serial input/output terminals for receiving a command from main controller 100 or transferring a command to other devices.

Digital audio processor 110 has a number of functions as seen below.

First, it unifies levels of sound sources that are inputted from different sound devices or converts the level of sound sources to ones a user wants.

Second, it receives sound signals from 16 different sound sources, and outputs the signals to 8 of them.

Third, it has a built-in equalizer adjustment function of 5 bands, so users can easily make an adjustment whenever they want.

Fourth, it can adjust an output level by output channels.

Fifth, in case of using a plurality of digital audio processors, only one digital audio processor receives input from sound sources. The other digital audio processors are accessed to a connection terminal mounted in the digital audio processor that received input first. As a result thereof, countless amounts of devices can be connected to one another by a simple connection.

Sixth, it has two contact output terminals, whereby it can control a power supply. Consequently, the amplifier remains turned off, and is automatically turned on only if it needs to be used.

Seventh, input channels 1 and 2 can vary the levels of sound sources. Therefore, a user can select a desired level for the microphone or line. Moreover, the user is recommended to use either a dynamic microphone or a condenser microphone whichever the user prefers.

Eighth, since it uses a graphic LCD, the user can check the operational state of the current devices, thereby allowing the user to set the desirable operational state.

Amplifier fault detector 120 is a multi-controller for establishing a proper system of a large scaled voice broadcasting network. It indicates whether there is any fault in the amplifier. As for an area with a faulty amplifier, it automatically switches the faulty amplifiers off by an extra auxiliary amplifier.

Emergency switcher 178, which is connected to main controller 100, transfers data. More specifically, signals inputted in emergency switcher 178 are usually fire signals, like a contact signal from a fire contact point or a pre-designated voltage signal (e.g. +24V). When emergency switcher 78 receives a fire signal from the fire contact point, it sends data on the origin of the fire signal to main controller 100. On the other hand, if the emergency switcher has a problem in sending the fire signal from the fire contact point, the main controller can manually receive the fire signal on a particular area through a switch installed in the front surface of the devices.

Speaker selector 179 enables a user to select a particular area he wants to receive broadcasts. When the user selects a switch on the front surface of the devices, an input signal of the speaker selector is ready to receive a selected signal for that particular area.

Permanent digital recorder and player 140 is useful especially when broadcasting appears to be virtually impossible. More specifically, permanent digital recorder and player 140 records programs (or contents) to be broadcasted, changes them to be in a broadcastable state, and transmits the pre-recorded broadcasts. Further, upon receiving a sound signal from the digital audio processor, permanent digital recorder and player 140 receives data from main controller 100 for informing that it is ready to broadcast, and then outputs the sound signal to the digital audio processor. Also, permanent digital recorder and player 140 has a built-in hard disk for storing high-capacity data.

Remote amplifier 180, which is connected to the main controller, selects a specific area for microphone broadcasting. Remote amplifier 180 includes a microprocessor, display, keypad, microphone terminal, and communication port. Hence, sound signals inputted through a microphone terminal or data signals inputted from a keypad are transmitted to the main controller. In this present embodiment, remote amplifier 180 is equipped with many circuits (i.e. 32 circuits), and preferably, each remote amplifier uses a separate switch. Moreover, the microphone installed in remote amplifier 180 is preferably a condenser microphone with high sensitivity in order to improve convenience and the ability to pick up sound.

For instance, remote amplifier 180 employed for the present embodiment has a built-in four-stage chime using a dual tone as a warning (notice) sound before broadcasting begins, and indicates an output level on a display to prevent over output. Preferably, an additional switch is used for keeping noises from being transmitted before and after broadcasting.

Relay group 130, with the help of signals outputted from the digital audio processor via the ampilifier fault detector, selects a speaker of a specific area for broadcast to be transmitted. If a relay connected to the speaker of a particular area is on, inputted signals are outputted to the speaker of that area. To output signals from the relay to the speaker, an output end of the relay consists of a general speaker line that operates in response to a normal signal in every channel, and an emergency speaker line that operates in response to an inputted emergency signal. Further, the relay group includes a LED for displaying its actions, thereby indicating whether the circuit in progress is under normal broadcast or under emergency broadcast.

Preferably, relay group 130 is mounted with a detection circuit (not shown) inside. In this way, relay group 130 has an operation confirmation function, whereby it can monitor emergency and general broadcasting and can check system operations. Also, relay group 130 has a link detect function, whereby it can check if there are any problems or faults with the speaker line.

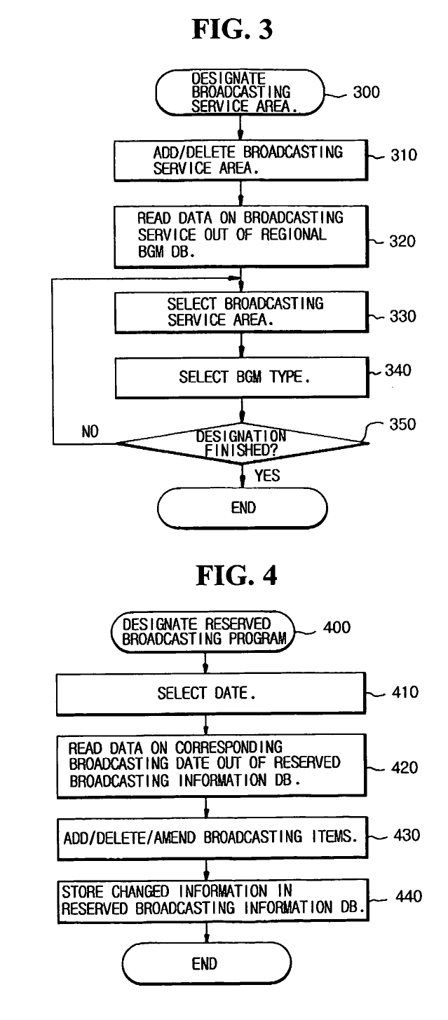

FIGS. 3 through 11 illustrate flow charts describing how operations of the main controller, which is installed in the intelligent broadcasting control system of the present invention, can work in connection with the checking and controlling functions. More details on each function will be discussed below.

FIG. 3 is an explanatory flow chart relevant to designating a broadcasting service area.

Referring now to FIG. 3, a broadcasting service area is added or deleted adaptive to a pre-configured system (S310). After selecting a wanted broadcasting service area (S330), background music (hereinafter referred to as “BGM”) available for the selected broadcasting service area is read out of the regional BGM database of the main controller, wherein all types of regional BGM relevant information is recorded. By selecting one of the BGM types (S340), the designation of a broadcasting service area is completed.

FIG. 4 is an explanatory flow chart relevant to designating a reserved broadcast.

Referring now to FIG. 4, after designating a reserved broadcast (S400), a user selects a date for editing (S410), and finds out from reserved broadcast information DB, if there is already reserved broadcasting information corresponding to the date. If there is, the reserved information is read out (S420). Then, the user may add, delete, and adjust (or amend) the reserved broadcast information as he wishes (S430). However, if there is pre-reserved information, the user inputs new reserved broadcast information. This amended or newly inputted reserved broadcast information is stored in the DB again (S440), and the designation of a reserved broadcast step is completed.

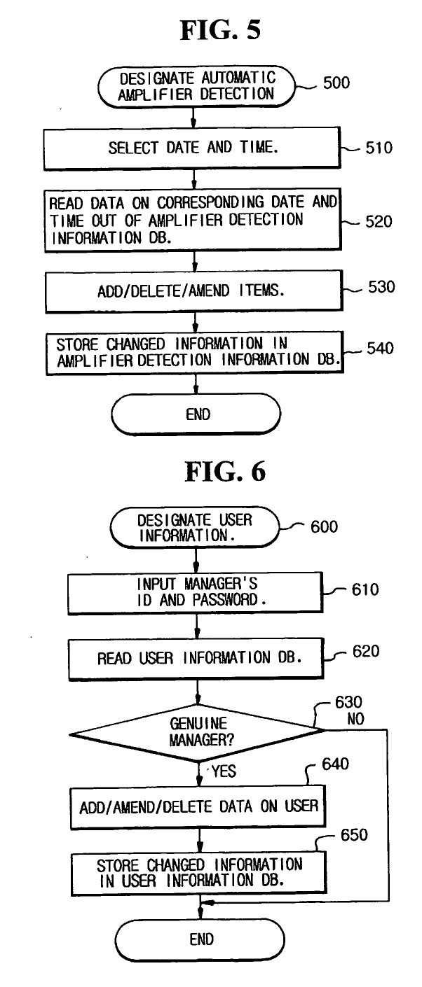

Turning now to FIG. 5, the main controller's function relevant to automatic amplifier detection will be explained below.

Referring to the drawing in FIG. 5, after designating automatic amplifier detection (S500), the user selects a date for editing (S510), and determines if there is a pre-designated amplifier detection information on the corresponding date in amplifier detection information DB (S520). If there is, the pre-designated information is read out, and the user may add, delete, and amend the information as he wishes (S530). However, if there is no pre-designated information, the user inputs new amplifier detection information. This amended or newly inputted amplifier detection information is stored again in the DB (S540); and the automatic amplifier detection is completed.

FIG. 6 is a flow chart explaining the designation of user information.

In FIG. 6, after selecting user information designation (S600), the user inputs an ID and password of the manager (or administrator) (S610). Next, the user determines if the inputted manager is a genuine manager or not by comparing the inputted information with pre-stored data in user information DB (S620). If it turns out that the inputted manager is not the genuine one, the designation of user information process is completed. However, if the inputted manager is proven to be the genuine one, the user may add, delete, or amend the user information as he wishes (S640). By storing the information in the user information DB (S650), the process is completed.

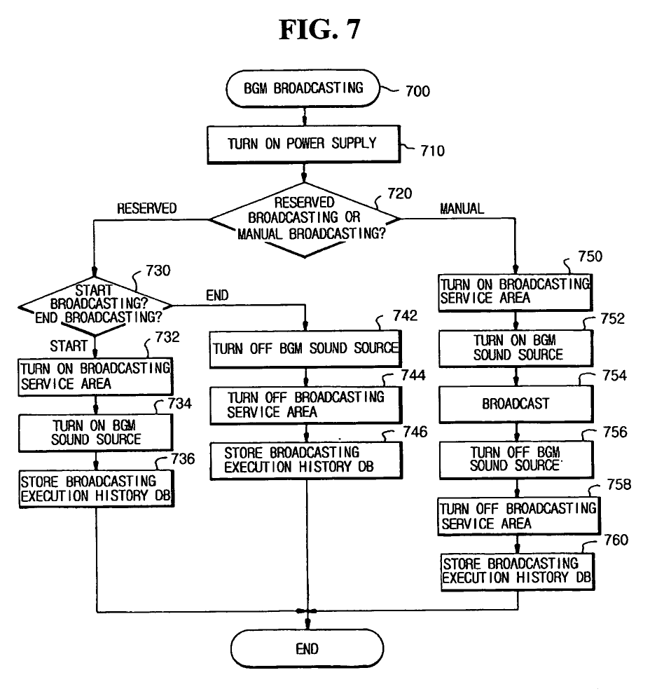

FIG. 7 is a flow chart explaining a BGM broadcast relevant function.

In FIG. 7, the user first checks the power supply of devices. If it is turned off, the user turns on the power, and then determines if the BGM broadcast is a pre-recorded (reserved) broadcast or a manual broadcast (S720).

If it is a manual broadcast, the user turns on the service area he wants, and selects a desired BGM sound source out of a CDP, DECK, or tuner (S752), and then broadcasts the selected one. When the broadcast is completed, the user turns off the power supply of the BGM sound source (S756) and the broadcasting service area is turned on (S758), thereby ending the broadcast (i.e. sign-off).

On the other hand, if it is a pre-recorded (reserved) broadcast, the user first finds out whether it is time to start or end the reserved broadcast (S730). If it is time to start the reserved broadcast, the user turns on a broadcasting service area (S732) and a BGM sound source. Meanwhile, if it is time to end the reserved broadcast, the user turns off the BGM sound source and the service area is turned on, thereby completes the broadcasting (i.e. sign-off)

Preferably, if the user needs to turn on/off the BGM sound source in each step, information relevant to this is stored in broadcasting history DB (S736, S746, and S760).

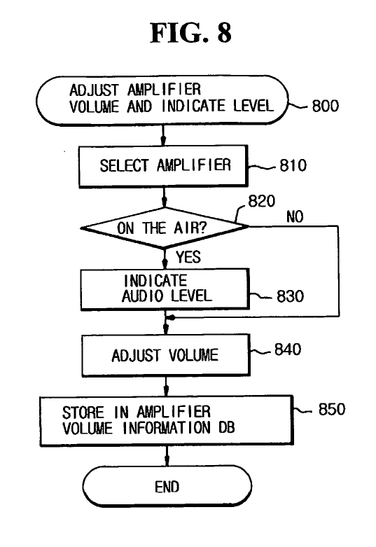

FIG. 8 is a flow chart explaining the amplifier volume adjustment/level indication function.

As shown in the drawing, when the amplifier volume adjustment/level indication is selected (S800), the user selects a wanted amplifier (S810). If the selected amplifier is already being used on air, the user indicates a sound level (S830). If not, the user adjusts the volume of the selected amplifier (S840), stores any relevant information in amplifier volume information DB (S850), and ends the amplifier volume adjustment/level indication function.

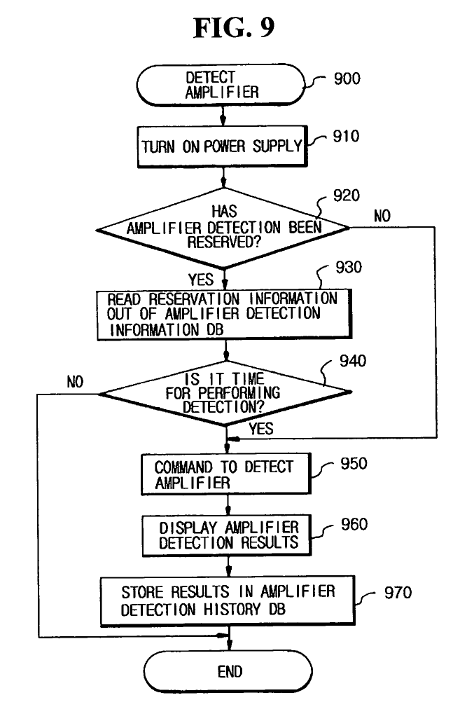

FIG. 9 is a flow chart explaining an amplifier detection function.

In FIG. 9, the user detects the power supply (S910). If the power supply has been turned off, the user turns on the power supply and finds out if the amplifier detection is already reserved or whether it should be done manually (S920).

If the amplifier detection should be done manually, the user gives an amplifier detection command to amplifier detection devices. When the results of the amplifier detection are displayed and the relevant information is stored in amplifier detection history DB, the process is completed.

On the other hand, if the amplifier detection is already reserved, the user checks if it is time to detect the amplifier (S930). If it is not that time, the user finishes the process. However, if it is that time, the user gives an amplifier detection command (S950). When the amplifier detection result is displayed (S960) and the relevant information is stored in the amplifier detection history DB (S970), the process is completed.

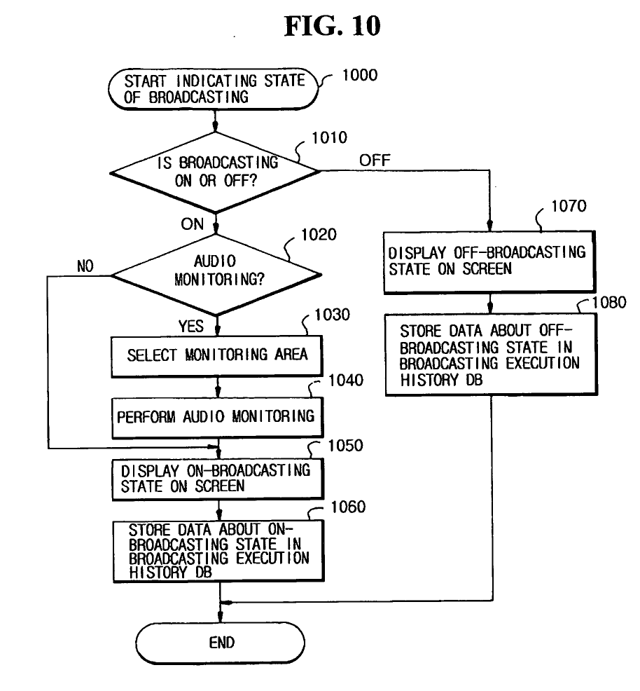

FIG. 10 is a flow chart explaining a broadcasting state/audio monitoring function.

In FIG. 10, the user determines whether the broadcasting is on or off (S1010).

If the broadcasting is on, the user chooses whether to perform audio monitoring on the broadcasting service area. If the user desires audio monitoring (S1020), he selects an area he wants to monitor (S1030) and executes the audio monitoring (S1040). Then, the user displays the state of broadcasting on a screen (S1050), and stores relevant information in the on-broadcasting execution history DB (S1060).

In the meantime, if the broadcasting is off, the user displays the state of broadcasting on the screen (S1070), stores relevant information in the off-broadcasting execution history DB (S1080), and ends the operation.

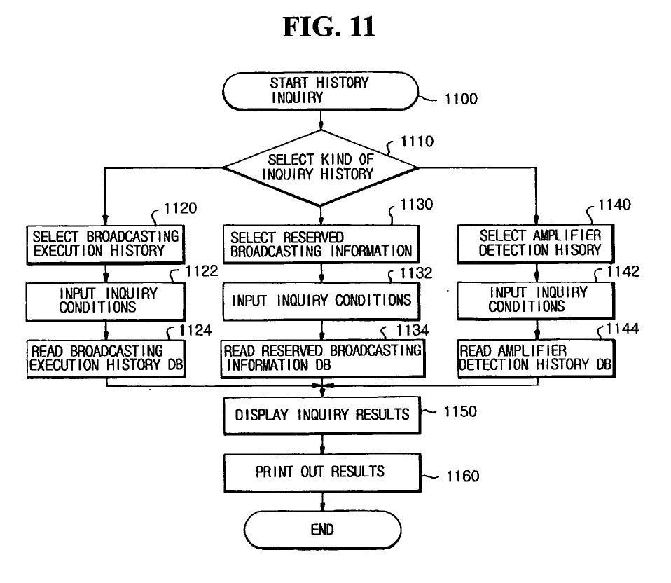

FIG. 11 is a flow chart explaining the functions in connection with broadcasting execution history, reservation information, and amplifier history inquiry/output.

To begin with, the user selects the type of history he wants to inquire/output.

When the user selects the broadcasting execution history (S1120), he inputs the inquiry conditions similar to the date and time he wants to inquire (S1122) about. After reading out the desired information from the broadcasting execution history DB, the user displays the result thereof on the screen (S1124). If he wants a written document, he may print out the results.

When the user selects the reserved broadcasting information (S1130), he inputs inquiry conditions similar to before (S1132). After reading out the desired information from the reserved broadcasting information DB, the user displays the results thereof on the screen (S1134). If the user wants a written document, he may print out the results.

When the user selects the amplifier detection history (S1140), he inputs the inquiry conditions (S1142). After reading out the desired information from the amplifier detection history DB (S1144), the user displays the results thereof on the screen (S1150). If he wants a written document, he may print out the results (S1160).

The user may keep making such inquiries, or may finish the process.

While the invention has been shown and described with reference to certain preferred embodiments thereof, it will be understood by those skilled in the art that various changes in form and details may be made therein without departing from the spirit and scope of the invention as defined by the appended claims.

### Industrial Applicability

The intelligent broadcasting control system of the present invention can be advantageously used in that it enables the user to change program setup conditions, as desired, according to the purpose of broadcasting from a certain place where the devices should be installed.

Moreover, the intelligent broadcasting control system of the present invention can be connected to an integrated system over the Internet, whereby users can get more diverse information on the system through the Internet and may use the system more conveniently.

What is claimed is:

1. An intelligent broadcasting control system mounted with a number of sound devices, the system comprising:
a main controller for checking the state of the system and controlling devices connected to the system;
a digital audio processor controlled by the main controller for adjusting the level of a sound source inputted from external sound source devices to a designated output level and outputting sounds;
an amplifier fault detector for self-detecting any faults in an amplifier connected to the system and automatically switching a faulty amplifier to an auxiliary amplifier;
a relay group for controlling the speaker to which sound signals outputted from the digital audio processor are outputted; disposed between the amplifier fault detector and a speaker;
a permanent digital recorder and player for recording a broadcasting program controlled by the main controller in case broadcasting itself becomes impossible and a broadcasting input is required from the outside, whereby a pre-recorded broadcasting program can be broadcasted when a broadcastable circumstance is presented at a later time.

2. The system according to claim 1, further comprising a computer connected to the main controller for setting up or monitoring the main controller.

3. The system according to claim 1, wherein the main controller controls the sound devices connected thereto by using a stream coding method.

4. The system according to claim 1, wherein the main controller is capable of performing data communication with the sound devices in real time mode.

5. The system according to claim 1, wherein the main controller sets off an alarm if faulty sound devices is found or displays how to take measures against faulty devices displayed on a screen.

6. The system according to claim 1, wherein the sound sources connected to the digital audio processor consist of at least one of a remote amplifier, microphone, CDP (CD player), DECK (cassette tape player), and tuner.

7. The system according to claim 1, wherein a plurality of digital audio processors are employed in the intelligent broadcasting control system, each digital audio processor being mounted with a connection terminal therein, sound sources are inputted in a single digital audio processor, and other digital audio processors are accessed to the connection terminal of the digital audio processor devices in which the sound sources are first inputted, thereby expanding the system.

8. The system according to claim 1, wherein the digital audio processor further comprises a graphic liquid crystal display (LCD).

9. The system according to claim 1, wherein a designated input channel mounted in the digital audio processor enables a user to vary the level of a sound source.

10. The system according to claim 1, wherein sound signals outputted from the digital audio processor are transferred to an amplifier, and the sound signals are transferred to an amplifier via the amplifier fault detector.

11. The system according to claim 1, further comprising an emergency controller for notifying the main controller if a certain area is on fire, wherein the emergency controller receives a fire signal from a fire contact point in case a fire breaks out in a certain area, and the emergency controller transmits data on the area of the fire to the main controller.

12. The system according to claim 11, wherein the emergency controller manually transmits data of the area on fire to the main controller if the fire signal is not received from the fire contact point despite the fact that a fire broke out in a certain area.

13. The system according to claim 1, further comprising a speaker selector, which enables a user to select a particular area the user wants to broadcast through a microphone of the main controller.

14. The system according to claim 1, further comprising:
a reserved broadcasting information database (DB); and
a reserved broadcasting designator mounted in the main controller for making reservations for a broadcasting date and storing pre-designated reservation information in the reserved broadcasting information DB.

15. The system according to claim 1, further comprising:
an amplifier detection information database (DB); and
an automatic amplifier detector mounted in the main controller for designating a date and time for amplifier detection and storing the designated information in the amplifier detection information DB.

16. The system according to claim 1, further comprising:
a user information database (DB); and
a user information designator mounted in the main controller for receiving an ID and password from a manager, which enables a user to add, amend, or delete information on the manager if inputted information on the manager conforms with pre-stored information in the user information DB.

17. The system according to claim 1, further comprising:
a background music (BGM) broadcaster mounted in the main controller, wherein the BGM performs the steps of:
determining if BGM to be broadcasted is pre-recorded (reserved) or should be broadcasted manually;
selecting and turning on a broadcasting service area, selecting a BGM sound source, and broadcasting the selected BGM, if the BGB is to be broadcasted manually;
turning on a reserved broadcasting service area and BGM sound source to start the broadcasting of the BGM unneeded space, while turning off the reserved broadcasting service area and BGM sound source for signing off the broadcasting of the BGM, if the BGB to be broadcasted has been pre-recorded.

18. The system according to claim 17, further comprising broadcasting execution history database (DB), wherein the BGM broadcaster of the main controller stores information relevant to turning on or off the BGM sound source in the broadcasting execution history DB.

19. The system according to claim 1, further comprising an amplifier volume information database (DB), wherein the main controller selects a specific amplifier, displays an audio level if the selected amplifier is already on the air, adjusts a volume of the selected Amplifier, and stores data related to the amplifier's volume adjustment in the amplifier volume information DB.

20. The system according to claim 15, further comprising:
an amplifier detection history database (DB); and
an amplifier detector mounted in the main controller, wherein the amplifier detector performs the steps of:
determining if amplifier detection is reserved or should be conducted manually;
if the amplifier detection has been reserved, determining if a reservation date and time pre-stored in the amplifier detection information DB conforms with a present time, and if it does, transferring an amplifier detection command to the amplifier detector;
if the amplifier detection should be conducted manually, transferring an amplifier detection command to the amplifier detector; and
displaying amplifier detection results, and storing amplifier detection history in the amplifier detection history DB.

21. The system according to claim 1, further comprising:
a broadcasting execution history database (DB); and
a broadcasting state displayer mounted in the main controller for storing an on/off state of the broadcasting execution history in the broadcasting execution history DB, wherein an audio in a particular area is monitored, if the broadcasting is on.

22. The system according to claim 1, wherein the relay group comprises detection circuits therein for detecting a fault or problem with a line between the relay group and the speaker, in which detection results are transmitted to the main controller.
